(19) United States
(12) Patent Application Publication
(10) Pub. No.: US 2020/0153633 A1
(43) Pub. Date: May 14, 2020

(54) DATA COMMUNICATION SYSTEM, DATA COMMUNICATION METHOD, SERVER, AND VEHICLE

(71) Applicants: Hyundai Motor Company, Seoul (KR); Kia Motors Corporation, Seoul (KR)

(72) Inventor: Seong Jin Park, Hwaseong (KR)

(21) Appl. No.: 16/299,282

(22) Filed: Mar. 12, 2019

(30) Foreign Application Priority Data
Nov. 14, 2018 (KR) 10-2018-0140200

(51) Int. Cl. H04L 9/32; H04W 4/44

(52) U.S. Cl. CPC H04L 9/3239; H04W 4/44

(57) ABSTRACT

The present disclosure relates to a data communication system, a data communication method, a server, and a vehicle. The data communication system may include: a data transmitting apparatus configured to generate a first hash value using one of a plurality of previous hash values as a first seed number, to encrypt data using the first hash value, and to transmit the encrypted data; and a data receiving apparatus configured to receive the data transmitted from the data transmitting apparatus, to separate the first hash value generated by the data transmitting apparatus from the data, to calculate a second hash value using one of the plurality of previous hash values as a second seed number, and to determine a validity of the data based upon whether the calculated second hash value coincides with the first hash value separated from the data.

### CROSS-REFERENCE TO RELATED APPLICATION

This application is based on and claims priority under 35 U.S.C. § 119 to Korean Patent Application No. 10-2018-0140200, filed on Nov. 14, 2018 in the Korean Intellectual Property Office, the disclosure of which is incorporated herein by reference in its entirety.

### TECHNICAL FIELD

Embodiments of the present disclosure relate to a vehicle, and more particularly, to data communication between the vehicle and a server.

### BACKGROUND

Data security is one of the most important factors for communication between a vehicle and a server. Conventionally, data has been constructed by adding a hash value to content to be transmitted in order to enhance the security of data communication. However, data security techniques based on usage of such hash values cannot reliably secure the transmitted content if the hash function for generating the hash value is exposed due to hacking or other malicious attacks.

### SUMMARY

It is an aspect of the present disclosure to improve data security in data communications between a data transmitting apparatus and a data receiving apparatus.

Additional aspects of the disclosure will be set forth in part in the description which follows and, in part, will be apparent from the description, or may be learned by practice of the disclosure.

In accordance with embodiments of the present disclosure, a data communication system may include: a data transmitting apparatus configured to generate a first hash value using one of a plurality of previous hash values as a first seed number, to encrypt data using the first hash value, and to transmit the encrypted data; and a data receiving apparatus configured to receive the data transmitted from the data transmitting apparatus, to separate the first hash value generated by the data transmitting apparatus from the data, to calculate a second hash value using one of the plurality of previous hash values as a second seed number, and to determine a validity of the data based upon whether the calculated second hash value coincides with the first hash value separated from the data.

The data transmitting apparatus may include a first delay function generator configured to generate the first seed number using one of the plurality of previous hash values.

The data receiving apparatus may include a second delay function generator configured to calculate the second seed number using one of the plurality of previous hash values.

The data receiving apparatus may include a comparator configured to compare the second hash value calculated using one of the plurality of previous hash values as the second seed number with the first hash value separated from the data and to determine whether the calculated second hash value coincides with the first hash value separated from the data.

The first seed number may use a predetermined initial value when the first hash value is generated by the data transmitting apparatus.

Furthermore, in accordance with embodiments of the present disclosure, a data communication method may include: generating, by a data transmitting apparatus, a first hash value using one of a plurality of previous hash values as a first seed number; encrypting, by the data transmitting apparatus, data using the first hash value; transmitting, by the data transmitting apparatus, the encrypted data; receiving, by a data receiving apparatus, the data transmitted from the data transmitting apparatus; separating, by the data receiving apparatus, the first hash value generated by the data transmitting apparatus from the data; calculating, by the data receiving apparatus, a second hash value using one of the plurality of previous hash values as a second seed number; and determining, by the data receiving apparatus, a validity of the data based upon wither the calculated second hash value coincides with the first hash value separated from the data.

The method may further include generating, by the data transmitting apparatus, the first seed number using one of the plurality of previous hash values.

The method may further include calculating, by the data receiving apparatus, the second seed number using one of the previous hash values.

The method may further include comparing, by the data receiving apparatus, the second hash value calculated using one of the previous hash values as the second seed number with the first hash value separated from the data; and determining, by the data receiving apparatus, whether the calculated second hash value coincides with the first hash value separated from the data.

The first seed number may use a predetermined initial value when the first hash value is generated by the data transmitting apparatus.

Furthermore, in accordance with embodiments of the present disclosure, a data communication system may include: a server configured to generate a first hash value using one of a plurality of previous hash values as a first seed number, to encrypt data using the first hash value, and to transmit the encrypted data; and a vehicle configured to receive the data transmitted from the data transmitting apparatus, to separate the first hash value generated by the data transmitting apparatus from the data, to calculate a second hash value using one of the plurality of previous hash values as a second seed number, and to determine a validity of the data based upon whether the calculated second hash value coincides with the first hash value separated from the data.

Furthermore, in accordance with embodiments of the present disclosure, a server may include: a delay function generator configured to generate a previous hash value; a hash value generator configured to generate a new hash value using the previous hash value as a seed number; a data configurator configured to encrypt data using the new hash value; and a transmitter configured to transmit the encrypted data.

The seed number may use a predetermined initial value when the new hash value is generated by the hash value generator.

Furthermore, in accordance with embodiments of the present disclosure, a vehicle may include: a receiver configured to receive data encrypted using a first hash value; a data separator configured to separate the first hash value from the data; a delay function generator configured to calculate a seed number using a previous hash value and to calculate a second hash value using the calculated seed number; and a comparator configured to determine a validity of the data based upon whether the calculated second hash value coincides with the first hash value separated from the data.

The seed number may use a predetermined initial value when the first hash value is generated.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating communication between a vehicle and a telematics center (server) according to embodiments of the present disclosure;

FIG. 2 is a view illustrating a control system of each of the vehicle and a server according to embodiments of the present disclosure;

FIGS. 3A and 3B are views illustrating a vehicle control method according to embodiments of the present disclosure; and

FIG. 4 is a view specifically illustrating a mutual update confirmation process of the vehicle control method illustrated in FIGS. 3A and 3B.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit. The term “control unit” may refer to a hardware device that includes a memory and a processor. The memory is configured to store program instructions, and the processor is specifically programmed to execute the program instructions to perform one or more processes which are described further below. The control unit may control operation of units, modules, parts, devices, or the like, as described herein. Moreover, it is understood that the below methods may be executed by an apparatus comprising the control unit in conjunction with one or more other components, as would be appreciated by a person of ordinary skill in the art.

Furthermore, the control unit of the present disclosure may be embodied as non-transitory computer readable media containing executable program instructions executed by a processor. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed throughout a computer network so that the program instructions are stored and executed in a distributed fashion, e.g., by a telematics server or a Controller Area Network (CAN).

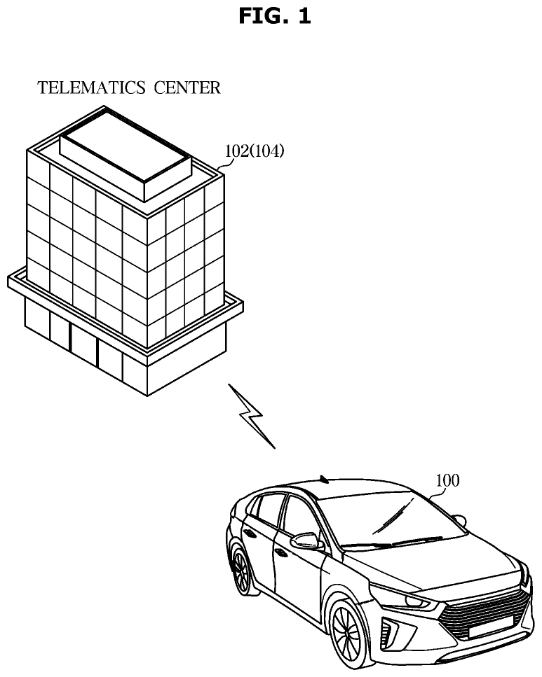

Referring now to the presently disclosed embodiments, FIG. 1 is a view illustrating communication between a vehicle and a telematics center (server) according to embodiments of the present disclosure.

As illustrated in FIG. 1, a vehicle 100 may communicate with a server 104 of a telematics center 102 located in a remote location. The server 104 of the telematics center 102 may support updating of software or firmware of various devices of the vehicle 100 through wireless communication. The server 104 and the vehicle 100 are elements constituting a data communication system as a data transmitting apparatus (i.e., server) for transmitting data and a data receiving apparatus (i.e., vehicle) for receiving data, respectively.

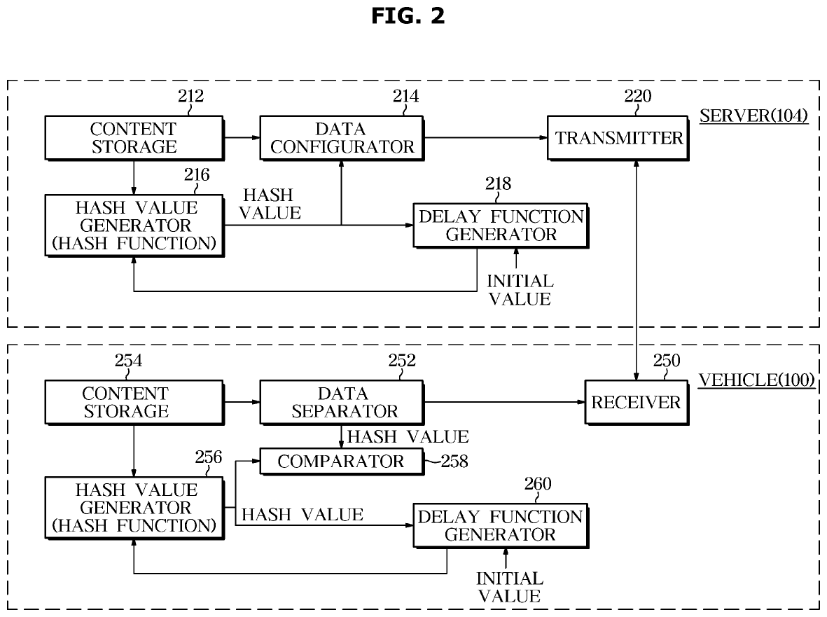

FIG. 2 is a view illustrating a control system of each of the vehicle and a server according to embodiments of the present disclosure.

The server 104 may add a hash value to the content necessary for updating the software or firmware of the vehicle 100 and transmit the added hash value to the vehicle 100. The server 104 may include a content storage 212, a data configurator 214, a hash value generator 216, a delay function generator 218 (i.e., first delay function generator), and a transmitter 220.

The content storage 212 of the server 104 may store content (i.e., data) to be transmitted from the server 104 to the vehicle 100. The content stored in the content storage 212 may be exemplified by software, firmware, set values, etc. to be driven by an electronic control unit (ECU) mounted in the vehicle 100. Alternatively, the content stored in the content storage 212 may be, for example, map data to be used for navigation.

The data configurator 214 may combine the hash value with the content (i.e., data) to be transmitted from the server 104 to the vehicle 100 and construct data to be transmitted. The hash value, alternatively referred to herein as a “first hash value,” is generated by the hash value generator 216 as described below.

The hash value generator 216 may generate a hash value and transmit the generated hash value to the data configurator 214 and the delay function generator 218. To this end, the hash value generator 216 may have a function for generating the hash value. The content of the content storage 212 and a seed number of the delay function generator 218 may be input to the hash value generator 216. The seed number, alternatively referred to herein as a “first seed number,” may be used to generate the hash value that is a random number.

The delay function generator 218 may store a previous seed number (i.e., initial value or hash value). The delay function generator 218 may receive an initial value. The initial value may be the seed number initially set in the delay function generator 218. When generating a first seed number, the initial value may be used. When generating a second and subsequent seed numbers, a new seed number may be generated by using a hash value generated in the past (for example, a hash value generated immediately before or a hash value generated at a specific time in the past). The initial values of the delay function generator 218 may have different values from vehicle to vehicle.

That is, an m-th generated hash value may be used as the seed number when generating a (m+1)-th hash value. The (m+1)-th generated hash value may be used as the seed number when generating a (m+2)-th hash value. The generation of the seed number is not limited to the use of the previous hash value, and any one of the previous hash values may be selected according to a promised rule and used for the generation of a new seed number. For example, a seed number before a fifth seed number may be used rather than the seed number generated most recently. Alternatively, a new seed number may be generated using the vehicle number.

The transmitter 220 may be provided to transmit data from the server 104 to the vehicle 100. The transmitter 220 may encrypt and transmit data.

The vehicle 100 may receive data (including content and hash values) necessary for updating the software or firmware from the server 104 and performs an update after confirming the hash value comparison. To this end, the vehicle 100 may include a receiver 250, a data separator 252, a content storage 254, a hash value generator (i.e., hash function) 256, a comparator 258, and a delay function generator 260 (i.e., second delay function generator).

The receiver 250 may be provided to receive data transmitted from the server 104 to the vehicle 100. The receiver 250 may release the encryption of the received data if necessary.

The data separator 252 may separate the content and the hash value from the data received through the receiver 250.

The content storage 254 may store the content in which the hash value is separated from the received data. The content stored in the content storage 254 may be used to update the software or firmware of the vehicle 100.

The hash value generator (i.e., hash function) 256 of the vehicle 100 may generate a hash value, alternatively referred to herein as a “second hash value,” and transmit the generated hash value to the comparator 258 and the delay function generator 260. To this end, the hash value generator 256 may have the function for generating the hash value. The content of the content storage 254 and a seed number of the delay function generator 260 may be input to the hash value generator 256. The seed number, alternatively referred to herein as a “second seed number,” may be used to generate a hash value that is a random number.

The comparator 258 may compare two hash values and confirm a match. One of the two hash values may be the hash value (i.e., first hash value) separated from the content in the data separator 252. The other of the two hash values may be the hash value (i.e., second hash value) generated by applying the hash function in the hash value generator 256. When the two hash values coincide with each other, it can be seen that the content transmitted from the server 104 is securely and received normally by the vehicle 100 and satisfies the completeness and validity.

The delay function generator 260 of the vehicle 100 may store a previous seed number (i.e., initial value or hash value) and generate a new seed number using the previous seed number (i.e., initial value or hash value). The delay function generator 260 may receive the initial value. The initial value may be the seed number initially set in the delay function generator 260. When generating a first hash value, the initial value may be used. When generating a second and subsequent hash values, a new hash value may be generated by using a hash value generated before, immediately before in some cases. The initial values of the delay function generator 260 may have different values from vehicle to vehicle.

The delay function generators 218 and 260 may be provided to further enhance the security of the data transmitted from the server 104 to the vehicle 100 in cooperation with the hash value generators 216 and 256. A higher level of security may be ensured when a hash value is generated from the hash value generators 216 and 256 based on the seed number generated by the delay function generators 218 and 260, as compared with a case where the hash value generators 216 and 256 independently generate a hash value. That is, primary security is ensured in the process of generating a seed number in the delay function generators 218 and 260, and additional secondary security is ensured in the process of generating a hash value in the hash value generators 216 and 256 based on the seed number of the delay function generators 218 and 260, so that a higher level of security can be assured compared with the case where the hash value generators 216 and 256 independently generate a hash value.

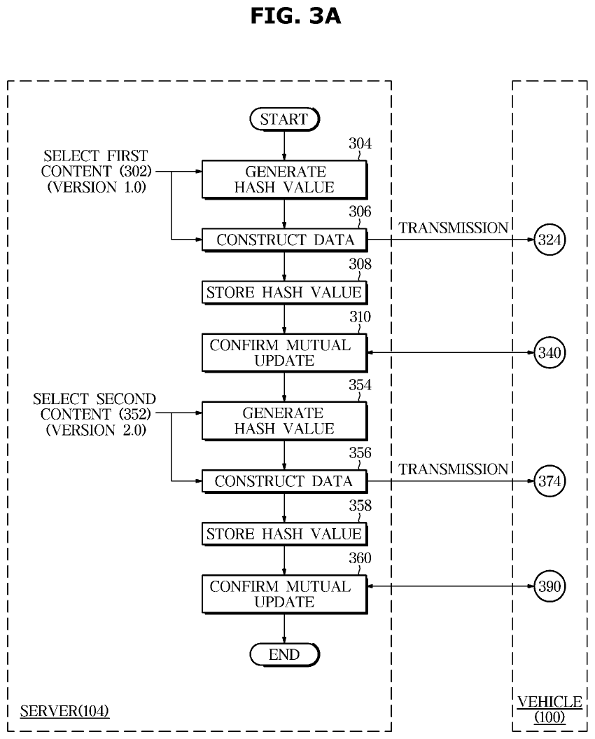

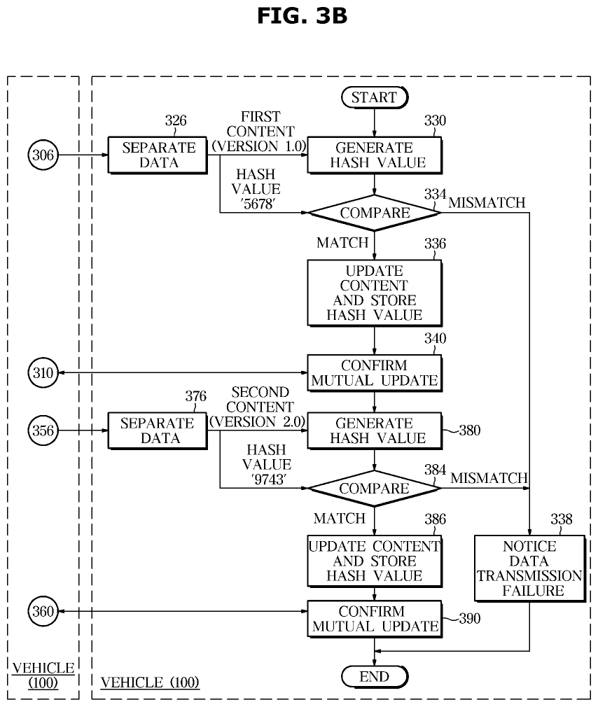

FIGS. 3A and 3B are views illustrating a vehicle control method according to embodiments of the present disclosure. FIG. 3A is a view illustrating a control in the server 104, and FIG. 3B is a view illustrating a control in the vehicle 100. Operations 306, 310, and 356 of the server 104 of FIG. 3A are each coupled to operations 324, 340, and 374 of the vehicle 100 of FIG. 3B. That is, the control operations of FIGS. 3A and 3B are not separate from each other, but comprise a series of processes for updating the software and/or firmware with mutual correlation such as transmission, reception, and confirmation. Therefore, a vehicle control method according to embodiments of the present disclosure will be described with reference to FIGS. 3A and 3B.

As illustrated in FIG. 3A, the server 104 may add a hash value to the content to be transmitted to the vehicle 100, construct and transmit the data, and store the hash value in the delay function generator 218.

First, the server 104 may select a first content to be transmitted to the vehicle 100 as a client (302). The first content may be, for example, the current version (version 1.0) of the software for driving the ECU. The selection of the first content may be in accordance with a predetermined software and/or firmware update schedule, or may be at a user's option.

When the first content to be transmitted to the vehicle 100 is selected, the hash value generator 216 may generate a hash value using the hash function (304). The hash value generator 216 may use an initial value (e.g., ‘1234’) provided through the delay function generator 218 when generating a hash value for the first time and generate a new hash value using a hash value generated before (immediately before) when the second and subsequent hash values are generated. In this example, the hash value generated first using the initial value is assumed to be ‘5678.’

Since the content to be transmitted (i.e., first content) and the hash value ‘5678’ are secured, the data configurator 214 may combine the first content with the hash value ‘5678’ to construct the data to be transmitted (306). That is, the data of <the first content+5678> type may be configured by the data configurator 214. The data is transmitted through the transmitter 220 to the vehicle 100, which is the client.

The hash value generator 216 of the server 104 may also transmit the generated hash value ‘5678’ to the delay function generator 218. The delay function generator 218 may store the hash value ‘5678’ received from the hash value generator 216. The hash value ‘5678’ stored in the delay function generator 218 may be used to generate the next hash value.

Through this process, the transfer of the first content (version 1.0) from the server 104 to the vehicle 100 may be completed.

Next, a process of updating in the vehicle 100 using the data transmitted from the server 104 will be described with reference to FIG. 3B.

As illustrated in FIG. 3B, the data separator 252 of the vehicle 100 may receive the data transmitted from the server 104 through the receiver 250 and separate the content and the hash value from the received data (326). That is, the received data may be separated into <first content (version 1.0)> and <hash value ‘5678’> through the separation process of the data separator 252.

When the reception and separation of the data is completed, the hash value generator 256 of the vehicle 100 may generate a hash value based on the received first content (version 1.0) (330). The hash value generated by the hash value generator 256 of the vehicle 100 at this time may be generated based on the first content and the initial value ‘1234,’ as in the hash value generator 216 of the server 104. Therefore, when data transmission is performed normally from the server 104 to the vehicle 100, the hash value of the data transmitted from the server 104 to the vehicle 100 and the hash value generated by the hash value generator 256 of the vehicle 100 should be equal to each other as ‘5678.’

The comparator 258 of the vehicle 100 may compare the hash value of the data transmitted from the server 104 to the vehicle 100 and the hash value generated by the hash value generator 256 of the vehicle 100 (334). The comparison of the comparator 258 is to confirm whether the hash value of the data transmitted from the server 104 to the vehicle 100 and the hash value generated by the hash value generator 256 of the vehicle 100 coincide with each other.

When the hash value of the data transmitted from the server 104 to the vehicle 100 and the hash value generated by the hash value generator 256 of the vehicle 100 coincide with each other as ‘5678’ (MATCH in 334), the vehicle 100 may perform an update using the received first content (version 1.0), and the hash value ‘5678’ is stored in the delay function generator 260 of the vehicle 100 (336). The stored hash value ‘5678’ may be used to generate the next hash value.

Through this series of processes, the server 104 may transmit data for updating to the vehicle 100 and receive data from the vehicle 100 to perform the updating. Next, a process of confirming whether or not the hash values stored in the delay function generator 218 of both the server 104 and the vehicle 100 are coincident (i.e., synchronized) may be performed. To this end, mutual update confirmation 310 of FIG. 3A and mutual update confirmation 340 of FIG. 3B may be performed.

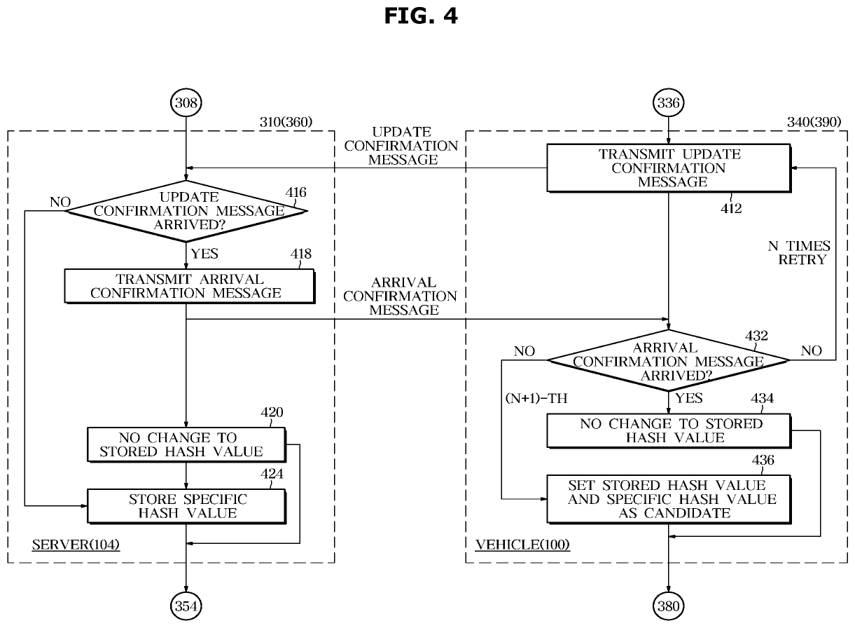

The specific contents of the mutual update confirmation 310 of FIG. 3A and the mutual update confirmation 340 of FIG. 3B will be described in detail in FIG. 4 later.

Returning to FIG. 3A, after the update of the primary software and/or firmware in the vehicle 100 through the transmission of the first content of the vehicle 100 from the server 104, an update request from the existing first content to the new first content may be generated. In this case, the server 104 may select a second content to be transmitted to the vehicle 100 as a client, as illustrated in FIG. 3A (352). The second content may be, for example, a new version (version 2.0) of software for driving the ECU. The selection of the second content may be in accordance with the predetermined software and/or firmware update schedule, or may be at the user's option.

When the second content to be transmitted to the vehicle 100 is selected, the hash value generator 216 may generate a hash value using the hash function (354). The hash value generator 216 of the server 104 has generated the hash value ‘5678’ using the initial value ‘1234’ for the transmission of the first content. At the time of transmitting the second content, a new hash value for transmission of the second content may be generated using the hash value ‘5678’ generated in the previous step and stored in the delay function generator 218. In the embodiment, the new hash value generated using the existing hash value ‘5678’ is assumed to be ‘9743.’

Since the content to be transmitted (i.e., second content) and the hash value ‘9743’ are secured, the data configurator 214 may combine the second content with the hash value ‘9743’ to construct the data to be transmitted (356). That is, the data of <the second content+9743> type may be configured by the data configurator 214. The data is transmitted through the transmitter 220 to the vehicle 100, which is the client.

The hash value generator 216 of the server 104 may also transmit the generated hash value ‘9743’ to the delay function generator 218. The delay function generator 218 may store the hash value ‘9743’ received from the hash value generator 216. The new hash value ‘9743’ stored in the delay function generator 218 may be used to generate the next hash value.

Through this process, the transfer of the second content (version 2.0) from the server 104 to the vehicle 100 may be completed.

The vehicle 100 that has already completed the update using the first content (version 1.0) may perform the update once more using new data (version 2.0) transmitted from the server 104. Hereinafter, a process of further updating the vehicle 100 using new content transmitted from the server 104 will be described with reference to FIG. 3B.

As illustrated in FIG. 3B, the data separator 252 of the vehicle 100 may receive the data transmitted from the server 104 through the receiver 250 and separate the content and the hash value from the received data (376). That is, the received data may be separated into <second content (version 2.0)> and <hash value ‘9743′> through the separation process of the data separator 252.

When the reception and separation of the data is completed, the hash value generator 256 of the vehicle 100 may generate a hash value based on the received second content (version 2.0) (380). The hash value generated by the hash value generator 256 of the vehicle 100 at this time may be generated based on the second content and the previous hash value ‘5678’ stored in the delay function generator 260, as in the hash value generator 216 of the server 104. Therefore, when data transmission is performed normally from the server 104 to the vehicle 100, the hash value of the data transmitted from the server 104 to the vehicle 100 and the hash value generated by the hash value generator 256 of the vehicle 100 should be equal to each other as ‘9743.’

The comparator 258 of the vehicle 100 may compare the hash value of the data transmitted from the server 104 to the vehicle 100 and the hash value generated by the hash value generator 256 of the vehicle 100 (334). The comparison of the comparator 258 is to confirm whether the hash value of the data transmitted from the server 104 to the vehicle 100 and the hash value generated by the hash value generator 256 of the vehicle 100 coincide with each other.

When the hash value of the data transmitted from the server 104 to the vehicle 100 and the hash value generated by the hash value generator 256 of the vehicle 100 coincide with each other as ‘9743’ (MATCH in 384), the vehicle 100 may perform an update using the received second content (version 2.0), and the hash value ‘9743’ is stored in the delay function generator 260 of the vehicle 100 (386). The stored hash value ‘9743’ may be used to generate the next hash value.

Through this series of processes, the server 104 may transmit data for updating to the vehicle 100 and receive data from the vehicle 100 to perform the updating. Next, a process of confirming whether or not the hash values stored in the delay function generator 218 of both the server 104 and the vehicle 100 are coincident (i.e., synchronized) may be performed. To this end, the mutual update confirmation 310 of FIG. 3A and the mutual update confirmation 340 of FIG. 3B may be performed.

The specific contents of the mutual update confirmation 310 of FIG. 3A and the mutual update confirmation 340 of FIG. 3B will be described in detail in FIG. 4 later.

When the two hash values to be compared in the comparison operations 334 and 384 in FIG. 3B do not coincide with each other (MISMATCH in 334 and 384), it is determined that the data transmission from the server 104 to the vehicle 100 is not performed normally and the user is notified that the update of the software and/or firmware is not performed normally by informing the user of the data transmission failure (338).

FIG. 4 is a view specifically illustrating a mutual update confirmation process of the vehicle control method illustrated in FIGS. 3A and 3B. When the update of the software and/or firmware in the vehicle 100 is completed using the contents of the data transmitted from the server 104 to the vehicle 100, the server 104 and the vehicle 100 may perform a series of processes to confirm whether the update is completed normally. When the server 104 does not respond normally to the confirmation request from the vehicle 100 to the server 104, both the server 104 and the vehicle 100 perform the mutual update confirmation process to match the hash values.

As illustrated in FIG. 4, the vehicle 100 may transmit an update confirmation message to the server 104 to notify the server 104 that the update has been completed (412).

The server 104 may recognize that the software and/or firmware has been updated normally in the vehicle 100 by receiving the update confirmation message transmitted from the vehicle 100. Accordingly, when the update confirmation message transmitted from the vehicle 100 arrives normally at the server 104 (YES in 416), the server 104 may generate an arrival confirmation message and transmit it to the vehicle 100 (418).

In addition, since the update of the software and/or firmware has been completed normally and the server 104 has already responded to the request of the vehicle 100 for confirmation, the server 104 may maintain the hash value stored in the delay function generator 218 of the server 104 without changing (420).

In step 416, to determine if the update confirmation message has arrived, when the update confirmation message has not arrived (NO in 416), a new specific function may be stored in the delay function generator 218 of the server 104 (424).

The vehicle 100 may confirm whether an arrival confirmation message is received from the server 104 (432).

Since the update of the software and/or firmware has been completed normally and the server 104 has already responded to the request of the vehicle 100 for confirmation, when the arrival confirmation message is received from the server 104 (YES in 432), the vehicle 100 may maintain the hash value stored in the delay function generator 218 of the vehicle 100 without changing (434).

When the arrival confirmation message is not received from the server 104 (NO and n times retry in 432), the vehicle 100 may retry the confirmation process a predetermined number of times (e.g., n times) in order to accurately confirm whether the arrival confirmation message is received from the server 104.

Alternatively, when the arrival confirmation message is not received from the server 104 (NO and (n+1)-th times in 432) despite n attempts, the vehicle 100 may set a specific hash value together with the hash value stored in the delay function generator 260 as a seed number candidate to be used in the generation of the next hash value (436).

When generating the next hash value, a new hash value is generated by using the previous hash value, i.e., the hash value stored in the current delay function generator 260 as the seed number, and it is confirmed whether the new hash value matches the hash value generated in the server 104. When the hash values do not match, a new hash value may be generated by using the specific hash value set as the candidate as the seed number.

The specific hash value mentioned in the above-described step 424 of the server 104 and the specific hash value set as the candidate in the vehicle 100 should be set in the same method predetermined between the server 104 and the vehicle 100 in advance. For example, the initial value may be set to the specific hash value. Alternatively, the hash value before the most recently stored hash value may be set to the specific hash value. In addition, a value generated by applying a predetermined function predetermined to a vehicle identification number may be set as the specific hash value.

Through this process, synchronization between the server 104 and the vehicle 100 for generating a hash value is performed, and a hash value of a predetermined type may be generated.

As is apparent from the above description, applying embodiments of the present disclosure, the security of data in data communication between the data transmitting apparatus and the data receiving apparatus can be enhanced.

The above description of the present disclosure is for illustrative purposes, and a person having ordinary skilled in the art should appreciate that other specific modifications may be easily made without departing from the technical spirit or essential features of the present disclosure. Therefore, the above embodiments should be regarded as illustrative rather than limitative in all aspects. The scope of the disclosure is not to be limited by the detailed description set forth above, but by the accompanying claims of the present disclosure, and it should also be understood that all changes or modifications derived from the definitions and scope of the claims and their equivalents fall within the scope of the present disclosure.

What is claimed is:

1. A data communication system comprising:
a data transmitting apparatus configured to generate a first hash value using one of a plurality of previous hash values as a first seed number, to encrypt data using the first hash value, and to transmit the encrypted data; and
a data receiving apparatus configured to receive the data transmitted from the data transmitting apparatus, to separate the first hash value generated by the data transmitting apparatus from the data, to calculate a second hash value using one of the plurality of previous hash values as a second seed number, and to determine a validity of the data based upon whether the calculated second hash value coincides with the first hash value separated from the data.

2. The data communication system according to claim 1, wherein the data transmitting apparatus comprises:
a first delay function generator configured to generate the first seed number using one of the plurality of previous hash values.

3. The data communication system according to claim 1, wherein the data receiving apparatus comprises:
a second delay function generator configured to calculate the second seed number using one of the plurality of previous hash values.

4. The data communication system according to claim 1, wherein the data receiving apparatus comprises:
a comparator configured to compare the second hash value calculated using one of the plurality of previous hash values as the second seed number with the first hash value separated from the data and to determine whether the calculated second hash value coincides with the first hash value separated from the data.

5. The data communication system according to claim 1, wherein the first seed number uses a predetermined initial value when the first hash value is generated by the data transmitting apparatus.

6. A data communication method comprising:
generating, by a data transmitting apparatus, a first hash value using one of a plurality of previous hash values as a first seed number;
encrypting, by the data transmitting apparatus, data using the first hash value;
transmitting, by the data transmitting apparatus, the encrypted data;
receiving, by a data receiving apparatus, the data transmitted from the data transmitting apparatus;
separating, by the data receiving apparatus, the first hash value generated by the data transmitting apparatus from the data;
calculating, by the data receiving apparatus, a second hash value using one of the plurality of previous hash values as a second seed number; and
determining, by the data receiving apparatus, a validity of the data based upon wither the calculated second hash value coincides with the first hash value separated from the data.

7. The method according to claim 6, further comprising:
generating, by the data transmitting apparatus, the first seed number using one of the plurality of previous hash values.

8. The method according to claim 6, further comprising:
calculating, by the data receiving apparatus, the second seed number using one of the previous hash values.

9. The method according to claim 6, further comprising:
comparing, by the data receiving apparatus, the second hash value calculated using one of the previous hash values as the second seed number with the first hash value separated from the data; and
determining, by the data receiving apparatus, whether the calculated second hash value coincides with the first hash value separated from the data.

10. The method according to claim 6, wherein the first seed number uses a predetermined initial value when the first hash value is generated by the data transmitting apparatus.

11. A data communication system comprising:
a server configured to generate a first hash value using one of a plurality of previous hash values as a first seed number, to encrypt data using the first hash value, and to transmit the encrypted data; and
a vehicle configured to receive the data transmitted from the data transmitting apparatus, to separate the first hash value generated by the data transmitting apparatus from the data, to calculate a second hash value using one of the plurality of previous hash values as a second seed number, and to determine a validity of the data based upon whether the calculated second hash value coincides with the first hash value separated from the data.

12. A server comprising:
a delay function generator configured to generate a previous hash value;
a hash value generator configured to generate a new hash value using the previous hash value as a seed number;
a data configurator configured to encrypt data using the new hash value; and
a transmitter configured to transmit the encrypted data.

13. The server according to claim 12, wherein the seed number uses a predetermined initial value when the new hash value is generated by the hash value generator.

14. A vehicle comprising:
a receiver configured to receive data encrypted using a first hash value;
a data separator configured to separate the first hash value from the data;
a delay function generator configured to calculate a seed number using a previous hash value and to calculate a second hash value using the calculated seed number; and
a comparator configured to determine a validity of the data based upon whether the calculated second hash value coincides with the first hash value separated from the data.

15. The vehicle according to claim 14, wherein the seed number uses a predetermined initial value when the first hash value is generated.
